(19) United States
(12) Patent Application Publication
(10) Pub. No.: US 2007/0162344 A1
(43) Pub. Date: Jul. 12, 2007

(54) Targeted advertisement network that integrates with store-shopping

(76) Inventor: Jianfeng Jiang, San Jose, CA (US)

Correspondence Address: Jianfeng Jiang, 1075 McKay Dr., San Jose, CA, 95131, US

(21) Appl. No.: 11/717,850

(22) Filed: Mar. 15, 2007

Related U.S. Application Data
(63) Continuation of application No. 11/148,117, filed on Jun. 9, 2005.

(51) Int. Cl. G06Q 30/00

(52) U.S. Cl. 705/14

(57) ABSTRACT

A new targeted Advertisement network that integrates with store-shopping includes at least one on-line provider of advertisements, a network of computers with assigned attributes for displaying the advertisements, a module collecting the assigned attributes of the computers and delivering the advertisements to the computers accordingly, and a desktop program installed in each computer to run the ads and interface with viewers.

### FIELD OF INVENTION

This invention relates to on-line shopping, on-line gaming, on line entertainment, on line advertisements, out-of-home advertisements, electronic magazines, direct mails(DM) and e-commerce.

### BACKGROUND OF THE INVENTION

Over the past two years, a lot of business owners realize that using a mixture of videos, flashes, audio and pictures is much more effective in promoting their products or company images than using still image DMs. However there isn't any tool for businesses to easily make multimedia product catalogs and send them to their customers. On the other hand, lots of stores are printing thousands of copies of product catalogs every week and distribute them to their customers. It would be great if they can also easily make multimedia version of the DM and send to customers electronically or let the customers directly download them from the businesses' websites. It would also be great if they can make updates in customer's multimedia DM instantly to insert time-sensitive on-sale information. It will be even greater if the customer can make direct purchases if they like the product in the multimedia product catalog.

Lastly, lots of advertisers or suppliers want to advertise in the digital displays in brick & mortar stores, yet they have to rely on traditional method: they send the ads to the store or an ad agency, the store or ad agency will manually edit the content and download to selected displays. It would be great if suppliers or advertisers can select any displays and send multimedia ads directly to the digital displays in the stores.

The proposed network consists of two parts: one part is for advertisers to publish ads directly to electronic catalogs for viewer to download, the other part is for advertisers to send ads directly to the digital displays in public places.

For the first part, stores can easily make multimedia catalogs and let their customers download from a website. The stores can even let their suppliers submit ads and select which catalog and when to place their ads in the catalog, the actual contents of the catalogs are automatically compiled.

The second part consists of many computers in many public places, in stores along with different isles, in airport waiting areas, alongside the walking streets, etc. The shopping interest of people at above mentioned different places are different. In the stores, a shopper is looking for related goods in that specific isle. While in airport waiting areas, the viewers' shopping interests are more general, but the viewers' profile like income level, age, and shopping interest etc are still different for different places.

In short, the viewers' shopping profiles are different at different locations & different times, these shopping profiles will be decided by the person in charge of that specific displaying computer. With the knowledge of the shopping profiles, the ads can be delivered to these computers according to their viewers' shopping needs. In this way, advertisers can pay less and achieve better results.

The proposed network can let many independent advertisers select any of the displays in the network and submit when and how much time they want their ads played. The network will automatically make the ad-playing schedule for each terminal and download the corresponding contents to every terminal.

The proposed advertisement network can also be integrated with store-shopping using the method proposed in the patent by the same author “On Line Shopping Network that Integrates with Store-Shopping” Ser. No. 10/926413.

Basically, if a shopper is interested in buying a product in the ad, he can either pay through credit card, or he can take a coupon, or print out a ticket for that product and check out with the Cashier.

Moreover, each terminal can be connected with a bar-code scanner, so that when a shopper scans a product, all the detailed multimedia information about the product will be shown. This is much more useful than the price-check terminals currently used in some stores.

Furthermore, all the products shown in the terminals are listed in the affiliated web-site of the new targeted-advertisement network, the shopper can always check out from the web-site.

### SUMMARY OF THE INVENTION

In accordance with one aspect of the invention, the new targeted advertisement network that integrates with store-shopping allows the business owners to decide the shopping profiles of the viewers for each computer he is deploying in his store, he then recommends which categories of goods or Ads fit each computer. These profiles can be updated any time by the manager.

In accordance with another aspect of the invention, the network management module for the new targeted advertisement network gathers all the profiles for each computer and delivers the Ads to the computers accordingly.

In accordance with one other aspect of the invention, the advertisers can choose when and where and which display terminal to display their ads to achieve the best results with least amount of spending.

In accordance with one other aspect of the invention, each displaying terminal has a client list so that only advertisers in the client list can send ads to this terminal.

In accordance with one other aspect of the invention, many independent advertisers can simultaneously select when and where and which real display terminal to display their ads, the network management module automatically makes the ad-play schedule for each terminal according to the terminal's available time, advertiser's priority status and some other criteria.

In accordance with one other aspect of the invention, when there are many items of different categories are to be displayed in one terminal and the number of categories that can be displayed in one page is limited, the network management module will automatically compute the product directory tree for the terminal display.

In accordance with yet another aspect of the invention, the new targeted advertisement network can gather the viewing and sales history generated by the ads for each location and an effectiveness rating can be generated for each location and time, which provides feedback to the advertisers.

In accordance with yet another aspect of the invention, a desktop program in each terminal provides a unique user-interface suitable for accommodating many viewers in public places. The program will broadcast advertisements repeatedly if there are no viewer interactions. The ads have web-content format (dhtml, for example) so that the viewer can click on the ads and get many detailed information just like browsing ads in a web-site.

In accordance with another aspect of the invention, a barcode reader can be integrated with the display terminals such that when a user scans the barcode of a product, the detailed information including videos, pictures, text etc. will be displayed.

In accordance with one other aspect of the invention, many independent advertisers can simultaneously select when and which virtual display terminal(which is the Electronic catalog) to display their ads, the network management module automatically schedule the contents of the Electronic catalogs and viewers can download and read the electronic catalogs, the contents of which automatically updated whenever viewers' PC is connected to the internet.

In accordance with one last aspect of the invention, a bidding platform can be built for the advertisers to bid for the locations and times of displaying their ads. the advertisers can have access to the viewing and sales data for each terminal (in the stores or virtual E-catalogs) to help them decide the return-on-investments for each terminal.

### BRIEF DESCRIPTION OF THE DRAWINGS

FIG. 1 is a schematic representation of the new targeted advertisement network in accordance with the invention.

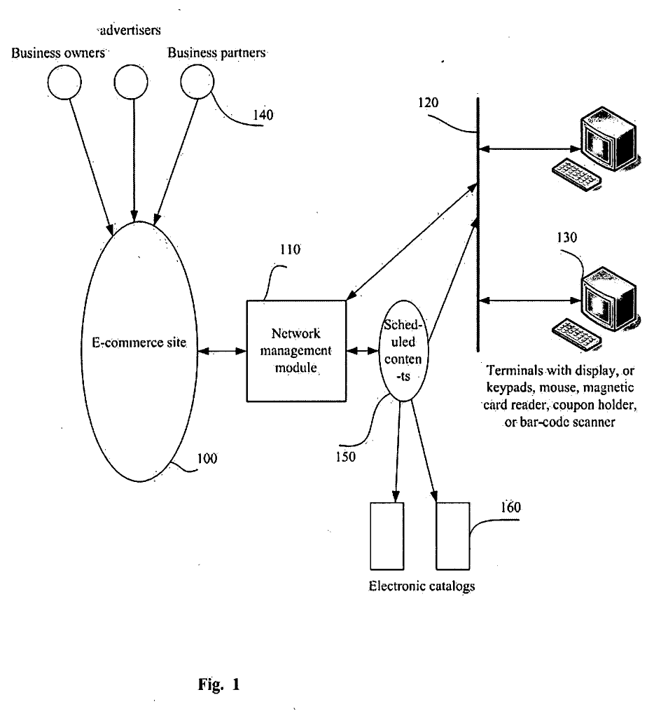

FIG. 2 is an example of the user-interface when there is no viewer interaction and a video is playing.

FIG. 3 is an example of the user-interface when there is no viewer interaction and several small ads are displayed in one page.

FIG. 4 is an example of the user-interface when there is user interaction, and ad category buttons are shown.

FIG. 5 shows an example of the daughter category of a parent button in FIG. 4

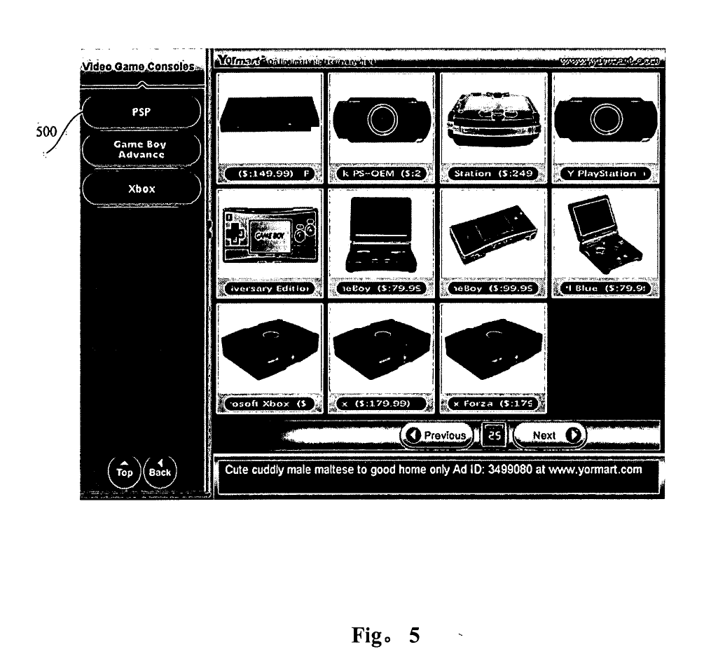

FIG. 6 shows an example of a detailed ad info. It is in web content format, or dhtml format.

FIG. 7 shows one example of the algorithm to compute the category buttons for each terminal

### DETAILED DESCRIPTION OF THE INVENTION

The present invention relates to a new targeted advertisement network that integrates with store-shopping. The following description is presented to enable one of ordinary skill in the art to make and use the invention as provided in the context of a particular application and its requirements. Various modifications to the preferred embodiment will be apparent to those with skill in the art and the general principles defined herein may be applied to other embodiments. Therefore, the present invention is not intended to be limited to the particular embodiments shown and described, but is to be accorded the widest scope consistent with the principles and novel features herein disclosed.

The new targeted advertisement network may include at least one e-commerce site 100. A network of terminals 130 may be coupled to the e-commerce site 100 by means of a distributed network such as the internet 120. Each terminal 130 may include display, keypads, mouse, computers, credit card readers, barcode scanners, printers and coupon holders.

The e-commerce site 100 has secured log-ins for advertisers and business owners 140. The business owners are responsible for placing the terminals 130 and determine the viewers' profiles and best ad categories for each terminal 130. The business owners can then log into their accounts at the e-commerce site 100 and input how many terminals 130 they have placed and what categories of ads and what times are best for each terminal 130. With these detailed information of the terminals 130, the advertisers can choose when and where to place their ads, so that they can spend less and achieve better results.

Each terminal 130 has a client list so that only advertisers in the client list can send ads directly to this terminal.

A network management module 110 then makes the scheduled-contents 150 for each terminal 130, i.e. What ads to display each day and in what order to display. The network management module 110 then downloads the corresponding ads to each terminal 130 through internet 120, and save them in the local hard-disk of each terminal 130.

Each terminal 130 has a desktop program that runs the ads and interfaces with the viewer. That is. If the viewer is interested in one ad, he can click at the ad to get more detailed information about the ad. He can make the purchase using credit card, or he can print out a ticket or coupon which has basic product info and seller's info. He can then contact seller directly, or give the ticket to the cashier to check out, or he can simply go home and check out the product through the website 100.

The scheduled contents 150 can also be put on the E-commerce site 100, in this case, we call the contents Electronic catalogs 160. Users can download the Electronic catalogs 160 and view the multimedia contents using a desktop program similar to the desktop program installed in terminals 130.

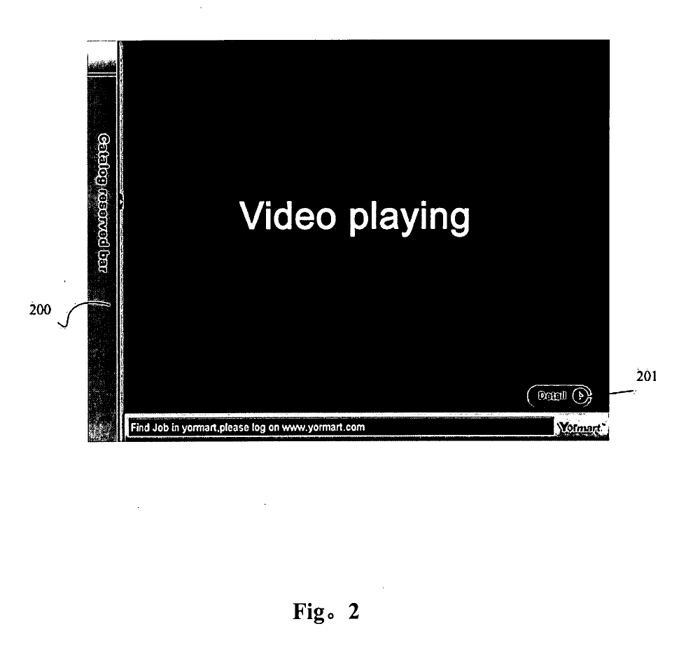

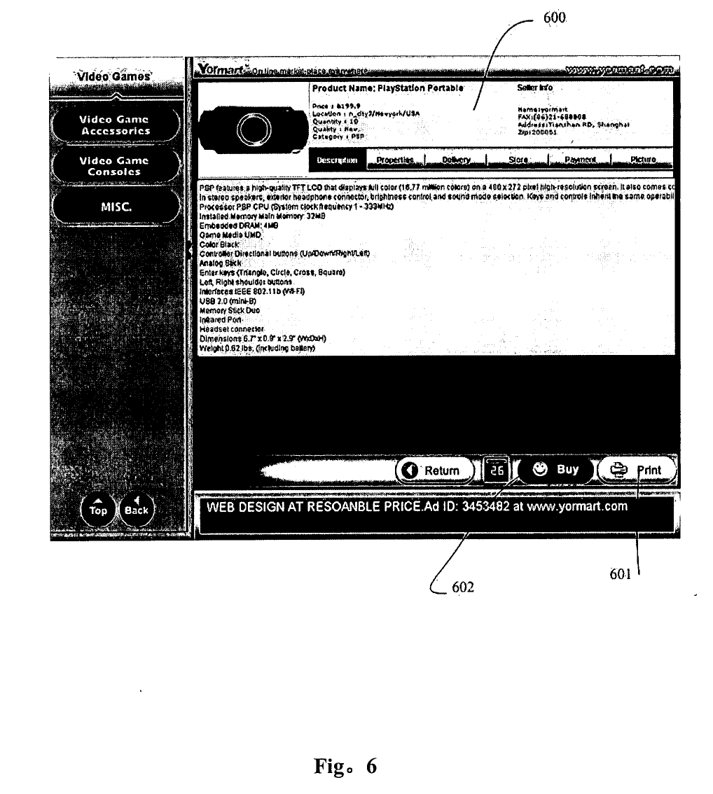

FIG. 2 shows the main state of the user-interface on terminals 130 when there are no viewer interactions and a video is playing. There is a “Detailed” button 201 that a viewer can touch to get more detailed information about the video ads. The detailed information 600 in FIG. 6 are in the web content format, or dhtml. A viewer can click on the ads and get many detailed information just like browsing ads in a web-site. In the detailed mode 600, the viewer may print out a ticket 601 showing information of the product and seller's contact information, or product's barcode. If the viewer is interested in buying the product, he can click on the buy button 602 to proceed.

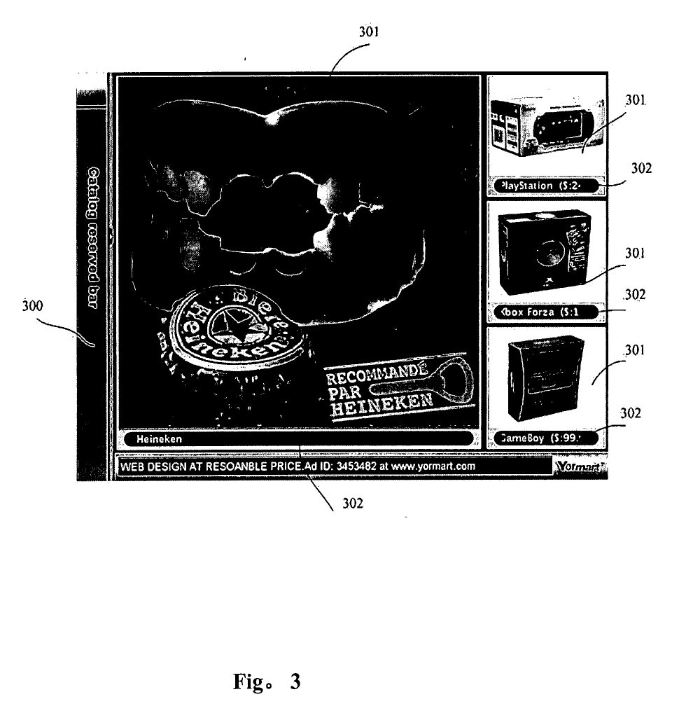

FIG. 3 shows the state of the user-interface when there are no viewer interactions and several small ads 301 are playing. The small ads 301 can be pure-picture ads or products ads as listed in the web-site, or a web content page (dhtml page), A viewer can touch each small ads to get more detailed information 600 about the ads. The detailed information 600 are in the web content format (dhtml format). The viewer can click on the ads and get many detailed information just like browsing ads in a web-site.

The small ads 301 can be a thumbnail image plus text info 302 such as the name of the product and its sales price. If the text info is too long to fit the allocated text space 302, the text will circulate or oscillate so that all texts will be shown.

The small ads 301 can be any size the advertiser requested. A desktop program automatically pick the small ads 301 and group them to fit one page to maximize the usage of the ad-spaces.

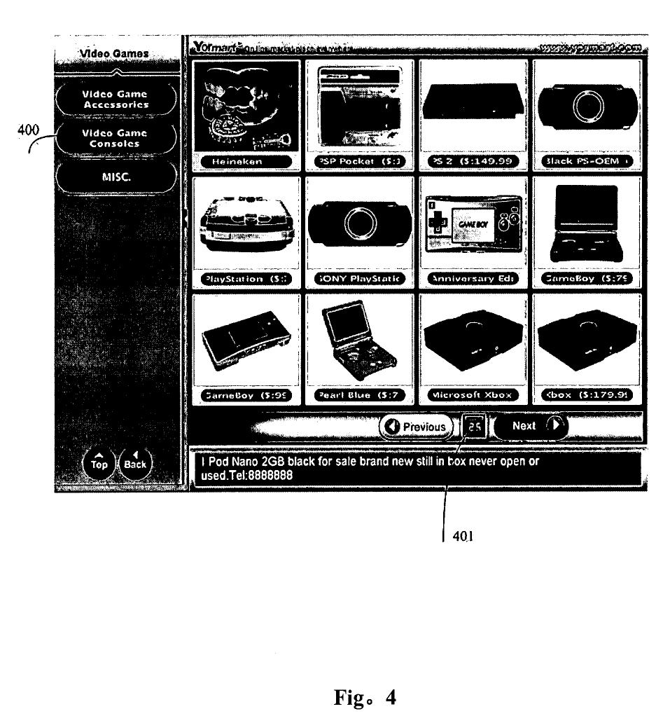

In FIG. 2 & FIG. 3, A viewer can touch the lefthand side bar 200 or 300 to enter the search mode FIG. 4. In addition to the ads shown in the auto-play mode FIG. 2 & FIG. 3, there are many more ads stored in the terminal that can be accessed through the search mode FIG. 4. There are some category buttons 400. A user can buy out a button 400 so that all of his ad listings are included under the button he bought. All of the rest of the listings not belonging to any user-bought-out buttons are included in the rest of the not-bought-out buttons. The button names are auto-generated according to the product directory trees of the e-commerce web-site 100 where the products are registered. Each button 400 can have children buttons 500 just like the web-site directory tree. A viewer can also touch any ads to see the detailed info 600 and print out a ticket 601 or click on buy button 602 to proceed to buy mode.

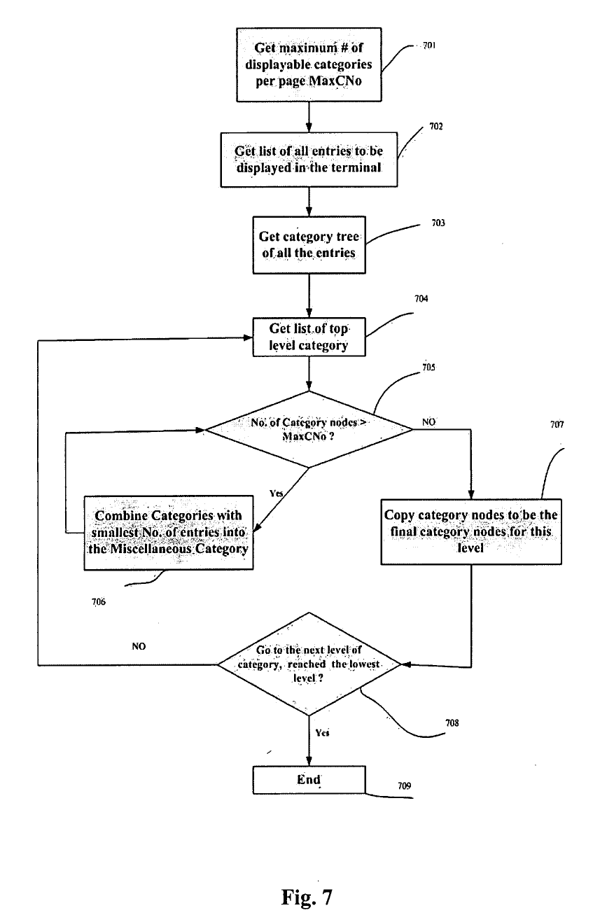

One exemplary algorithm for computing the buttons 400 or 500 are shown in FIG. 7. The basic steps are: 701)Get the maximum number of displayable category buttons 400 or 500 per page, which can be denoted as MaxCNo; 702) Get the list of all the product or advertisement entries to be displayed in a terminal; 703) Get the category tree of all the entries based on the category tree of the E-commerce site 100; 704) Get list of top categories that have valid product entries; 705) If the number of top categories are larger than the maximum number of displayable categories, then the categories with the smallest number of product entries will be absorbed into the miscellaneous category 706; otherwise the top level categories will be copied directly as the final top level categories 707; After the top level categories are set, go to the next level categories 708, repeat the steps 704 to 708, until the lowest levels of product categories are reached. It should be noted that further optimizations are made in the actual invention when number of category nodes are not greater than MaxCNo.

There is a time out feature 401 that will force the user-interface into the automatically broadcast mode if there are no user interactions within the time out period.

The desktop program also stores the viewer interface and sales history and uploads the data to the network management module 110. The data can be analyzed to establish an effectiveness rating for each terminal 130.

Each terminal 130 can be connected with a barcode scanner so that if a shopper scans a product, the detailed multimedia information about the product will be shown.

All the advertisements displayed at the public terminals 130 are available at the at least one e-commerce site 100, the buyer can also check out from the at least one e-commerce site 100. The buyers can also provide feedback for each Ad on when and where they saw the Ad. These feedback will also be used for the effectiveness rating system for all the terminals 130.

To save the cost of internet connections, a proxy server can be used to drive several terminals 130. The proxy server interacts with the e-commerce site 100 through the internet 120, while other terminals interact with the e-commerce site through the proxy server.

The following claims are therefore made:

1. A new targeted advertisement network comprising:
At least one on-line provider of advertisements;
A network of terminals coupled to the at least one on-line provider of advertisements;
A desktop program running on the terminals; and
A network management module.

2. The new targeted advertisement network of claim 1, wherein the on-line provider of advertisements sends ad contents to the network of terminals in web content format.

3. The new targeted advertisement network of claim 1, wherein multiple advertisers independently submit ads, specify which terminals and what dates to play ads and how much time each day to play the ads, the network management module automatically make the daily ad-play schedule for each terminal.

4. The new targeted advertisement network of claim 1, wherein each terminal has a client list so that only advertisers in the client list can send ads directly to this terminal.

5. The new targeted advertisement network of claim 1, wherein multiple advertisers can bid for ad-play time for any terminals according to the terminal profiles.

6. The new targeted advertisement network of claim 1, wherein terminals can be virtual, the scheduled contents for these virtual terminals are electronic catalogs for users to download.

7. the new targeted advertisement network of claim 2, wherein the web content format consists of dhtml format

8. The new targeted advertisement network of claim 1, wherein the desktop program comprises a user-interface

9. The new targeted advertisement network of claim 8, wherein the user-interface stays in the automatically broadcast mode in which the ads are played repeatedly if there are no user-interactions

10. The new targeted advertisement network of claim 8, wherein ads played by the user-interface can be clicked to view more detailed information about the ads.

11. The new targeted advertisement network of claim 8, wherein the user-interface has a timeout feature that forces the interface into the automatically broadcast mode if there are no user-interactions within the timeout period.

12. The new targeted advertisement network of claim 8, wherein the texts describing the ad name and selling price will oscillate or circulate if they are too long to fit in the allocated space for texts.

13. The new targeted advertisement network of claim 8, wherein several ads with different sizes are grouped together to fit in one page automatically by a program.

14. The new targeted advertisement network of claim 8, wherein ads are listed under their corresponding category buttons.

15. The new targeted advertisement network of claim 14, wherein the category buttons are generated automatically according to the product directory in the at least one on-line provider of advertisements.

16. The new targeted advertisement network of claim 14, wherein the category buttons are generated automatically using the following algorithm:
16.1. Get the maximum number of displayable category buttons per page, which can be denoted as MaxCNo;
16.2 Get the list of all the product or advertisement entries to be displayed in a terminal;
16.3 Get the category tree of all the entries based on the category tree of the E-commerce site where the entries are registered;
16.4 Get list of top categories that have non-zero product entries;
16.5 If the number of top categories are larger than the maximum number of displayable categories, then the categories with the smallest number of product entries will be absorbed into the Miscellaneous category; otherwise the top level categories will be copied directly as the final top level categories;
16.6 After the top level categories are set, go to the next level categories, repeat the steps 16.4 to 16.5, until the lowest levels of product categories are reached.

17. The new targeted advertisement network of claim 14, wherein all of a user's listed ads in a terminal fall into one category button if the user bought the right-of-use of the button.

18. The new targeted advertisement network of claim 1, wherein a terminal can be set as a proxy server so that several other terminals can be coupled to the at least one on-line provider of advertisements through the proxy server

19. The new targeted advertisement network of claim 8, wherein the user-interface couples with a barcode scanner, so that detailed multimedia information of a product can be shown by scanning the barcode.

20. An algorithm to compute the category buttons when there are many entries registered with one category tree are to be displayed with limited number of category buttons:
20.1 Get the maximum number of displayable category buttons, which can be denoted as MaxCNo;
20.2 Get the list of all the entries to be displayed;
20.3 Get the category tree of all the entries based on the category tree the entries are registered;
20.4 Get list of top categories that have non-zero entries;
20.5 If the number of top categories are larger than the maximum number of displayable categories, then absorb some categories into the Miscellaneous category; otherwise the top level categories will be copied directly as the final top level categories;
20.6 After the top level categories are set, go to the next level categories, repeat the steps 20.4 to 20.5, until the lowest levels of categories are reached.
